(19) United States
(12) Patent Application Publication
(10) Pub. No.: US 2026/0152987 A1
(43) Pub. Date: Jun. 4, 2026

(54) CHARGING MODULE FOR AN ELECTRIC VEHICLE

(71) Applicant: Motherson DRSC Deutschland GmbH, Kronach-Neuses (DE)

(72) Inventors: Frank Knorr, Kronach-Neuses (DE); Matthias Bayer, Kronach-Neuses (DE); Harald Fischer, Kronach-Neuses (DE)

(21) Appl. No.: 19/406,147

(22) Filed: Dec. 2, 2025

(30) Foreign Application Priority Data
Dec. 2, 2024 (DE) 102024135699.5

(51) Int. Cl. E05F 15/63; B60L 53/16

(52) U.S. Cl. CPC E05F 15/63; B60L 53/16; E05Y 2201/214; E05Y 2201/484; E05Y 2900/534

(57) ABSTRACT

The present invention discloses a charging module for an electric vehicle, with an actuator comprising a drive axis, a lid element comprising an output axis or connected with an output axis and a spring element configured to link the drive axis and the output axis, so that the output axis is coupled with the drive axis to open and close the lid element.

### CROSS REFERENCE TO RELATED APPLICATIONS

This application claims the benefit of German Patent Application No. DE 102024135699.5, filed on Dec. 2, 2024, the content of which is incorporated herein by reference in its entirety.

### TECHNICAL FIELD OF THE INVENTION

The present invention pertains to a charging module for an electric vehicle.

### TECHNICAL BACKGROUND CROSS REFERENCE TO RELATED APPLICATIONS

Considering a charging module for an electric vehicle, opening and closing of a lid of the charging module should be realized without damaging an actuator of the charging module.

In particular, if an object, e. g. a hand or a charging plug or the like, remains under the lid element when the lid element is about to close, the actuator, in particular an electric motor, is exposed to the risk of damage. In detail, if the lid element will be manually turned back to the opened position against the rotation direction of the drive axis of the electric motor, the electric motor will be turned backwards.

Against this background, it is an object of the present invention to provide an improved charging module. In particular, it is an object of the invention to provide a charging module with protection against manually backward rotation of the actuator.

This object is achieved by a charging module with the features of claim 1.

### SUMMARY OF THE INVENTION

The present invention discloses a charging module for an electric vehicle, with an actuator comprising a drive axis, a lid element comprising an output axis or connected with an output axis and a spring element configured to link the drive axis and the output axis, so that the output axis is coupled with the drive axis to open and close the lid element.

One idea of the present invention is to split the axis, in particular the output axis and the drive axis, and to link the axis via at least one spring element. In other words, the charging module may comprise a spring-clutch system.

The actuator may be an electric motor. The drive axis may be a rotor element with a drive shaft. The drive axis may comprise a drive shaft.

The output axis may be connected with the lid element. The output axis may be positioned at an arm element of the lid element.

Advantageously, since the drive axis and the output axis are separated (as separated) elements) and linked via the spring element, damage on the actuator and on the car electronics may be prevented because of the splitting of the axis.

One advantage of a spring-clutch system is a correlation between the drive axis and the output axis. Thus, according to the spring-clutch system the lid element (output) will always follow the actuator of the electric motor (driver) to position the lid element, in particular in an opened or closed position, or a position therebetween. Preferably, that means even when the spring-clutch system is activated the lid element will follow automatically the actuator of the electric motor. Advantageously, a calibration cycle and/or calibration operation is not necessary to match the position of the lid element to the actuator position.

Due to split axis, wherein the output axis and the drive axis are linked via a spring element, implementation of spring-loaded locking mechanism is implemented without additional actuator.

According to an embodiment, the drive axis of the actuator may also control the locking mechanism. With the spring element implemented in the locking mechanism an emergency opening/closing of the lid element via a cord (or something similar) may be realized.

In an embodiment of the present disclosure, the actuator comprises a rotor element having a drive shaft defining the drive axis and a rotor towing arm. According to an embodiment, the rotor towing arm is in parallel to the drive shaft. In particular, the rotor towing arm is spaced apart from the drive shaft. Advantageously, the rotor towing arm can rotate around the drive shaft when rotating the drive shaft at the drive axis.

According to an embodiment of the present disclosure, the lid element comprises an arm element having a lid cylinder element defining the output axis and a lid towing arm. The lid towing arm may be in parallel to the cylinder element. In particular, the lid towing arm is spaced apart from the lid cylinder element. Advantageously, the lid towing arm can rotate around the output axis when rotating the lid element at the output axis.

According to an embodiment of the present disclosure, the spring element is configured with a first slew arm and a second slew arm disposed at two opposite ends. One slew arm may contact the towing arm of the lid element, and one slew arm may contact the towing arm of the rotor element when rotating the rotor.

According to an embodiment of the present disclosure, the lid cylinder element and the drive shaft are coaxially inserted into each other to define a central axis of rotation such that the rotor towing arm and the lid towing arm are disposed between the first slew arm and the second slew arm, by pre-loading the spring element around the central axis of rotation to achieve the linking of the drive axis and the output axis.

According to an embodiment of the present disclosure, the spring element is configured to enable or disable transfer of torque between the rotor element and the arm element to achieve the opening and closing of the lid element.

In an embodiment of the present disclosure, the rotor towing arm is configured to engage with the first slew arm causing the second slew arm to engage with the lid towing arm thereby resulting in rotation of the rotor towing arm and the lid towing arm together as a single rotary body in a first direction to enable transfer of torque from the rotor element to the arm element causing opening of the lid element in absence of an opposing external force on the lid element.

According to an embodiment of the present disclosure, the rotor towing arm is configured to engage with the second slew arm causing the first slew arm to engage with the lid towing arm thereby resulting in rotation of the rotor towing arm and the lid towing arm together as the single rotary body in a second direction to enable transfer of torque from the rotor element to the arm element causing closing of the lid element in absence of an opposing external force on the charging lid.

In an embodiment of the present disclosure, the spring element is configured to absorb an opposing external force applied on the lid element, resulting in a relative movement of the rotor towing arm and the lid towing arm, thereby preventing the external force from being transferred to the rotor element.

In an embodiment of the present disclosure, the rotor element further comprises a rotor gearing, coaxially to the drive shaft, configured to be rotated by the actuator.

In an embodiment of the present disclosure, the rotor towing arm and the lid towing arm extend from the rotor element and the arm element correspondingly in opposite directions.

In an embodiment of the present disclosure, the disc-shaped protrusion is configured to be attached to the drive shaft and the rotor gearing, and configured to rotate with the drive shaft, wherein the disc-shaped protrusion comprises a planar portion and a contour portion.

According to an embodiment of the present disclosure, a lever element having a fixing point and a ball-shaped head, wherein the fixing point is configured to selectively engage with a contact point at the lid element.

According to an embodiment of the present disclosure, the ball-shaped head is configured for engaging with the planar portion during the opening and closing of the lid element, and for engaging with the contour portion causing the engagement of the fixing point with the contact point to lock the lid element during the closed position of the lid element.

In an embodiment of the present disclosure, the cord element is connected to the lever element, configured for manual disengagement of the fixing point of the locking lever element with the contact point thereby unlocking the lid element during an event of the actuator malfunction.

In an embodiment of the present disclosure, the spring element is a torsion spring.

The foregoing summary is illustrative only and is not intended to be in any way limiting. In addition to the illustrative aspects, embodiments, and features described above, further aspects, embodiments, and features will become apparent by reference to the drawings and the following detailed description.

It should be understood that any one of the described features and/or embodiments of the disclosure may be used separately or in combination with other disclosed features and/or embodiments.

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

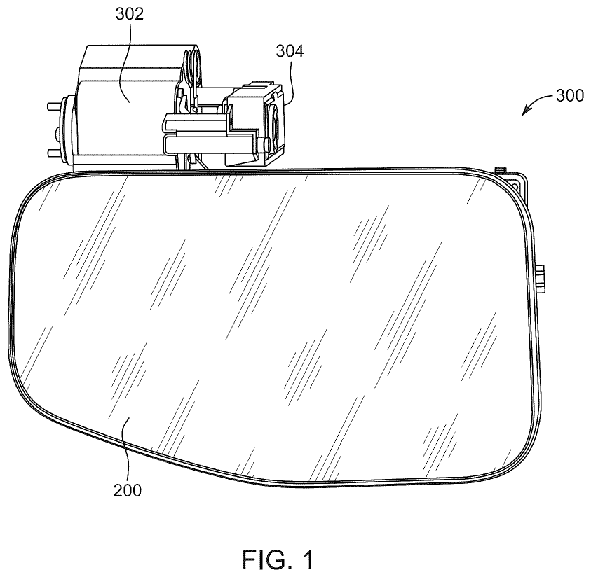

FIG. 1 illustrates a front of a charging module in accordance with an embodiment of the present disclosure;

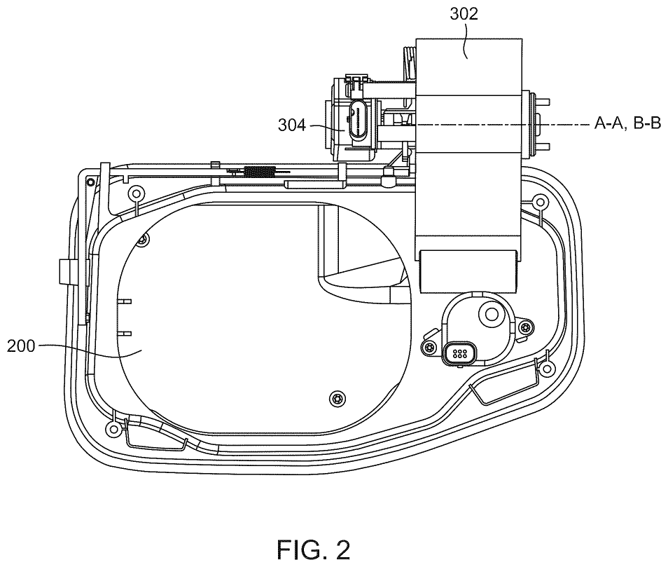

FIG. 2 illustrates a rear view of the charging module in accordance with an embodiment of the present disclosure;

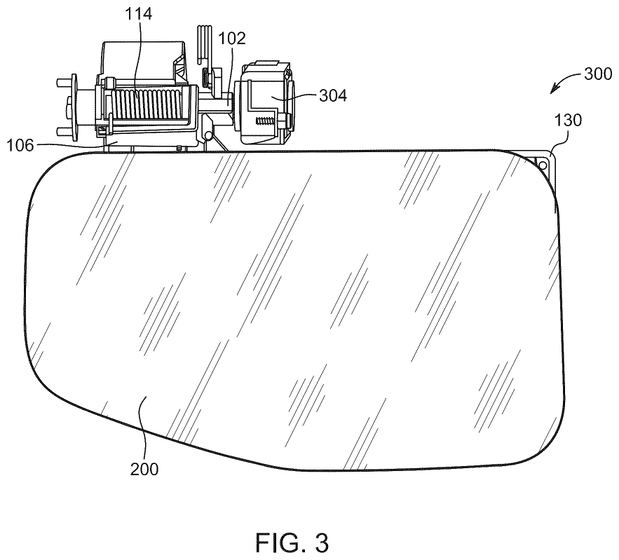

FIG. 3 illustrates the front of the charging module excluding a housing in accordance with an embodiment of the present disclosure;

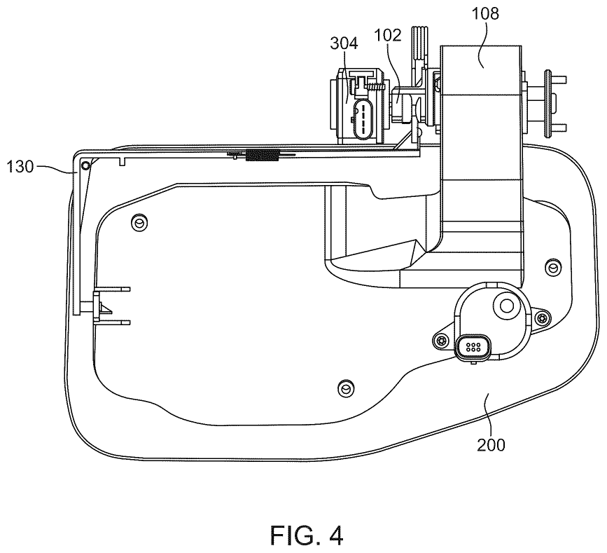

FIG. 4 illustrates the rear view of the charging module excluding the housing in accordance with an embodiment of the present disclosure;

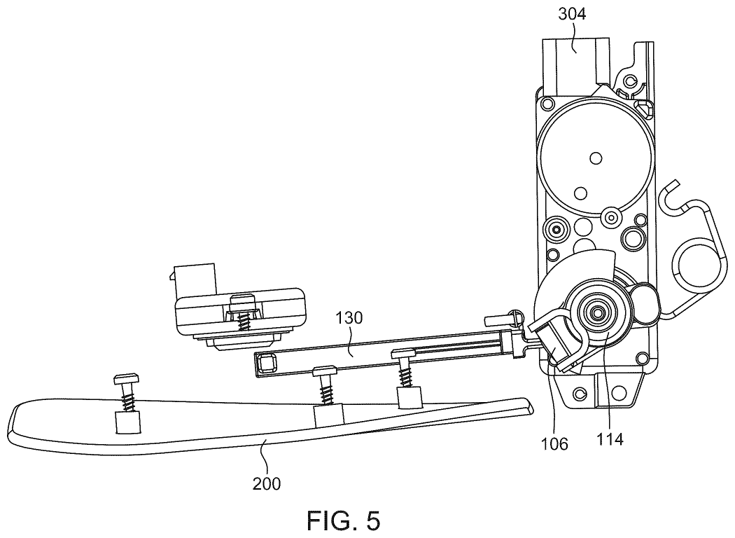

FIG. 5 illustrates an isometric view of the charging module excluding the housing, an arm element and a lid element in accordance with an embodiment of the present disclosure;

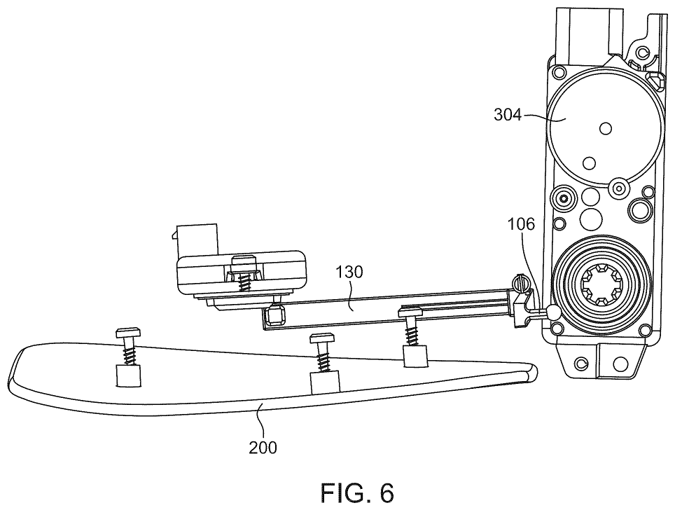

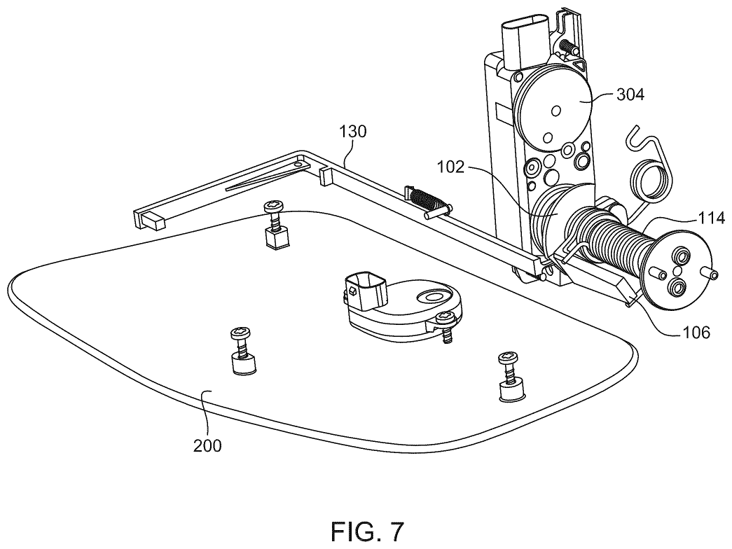

FIG. 6-7 illustrate perspective views of the FIG. 5 in accordance with an embodiment of the present disclosure;

FIG. 8 illustrates a perspective view of an actuator in accordance with an embodiment of the present disclosure;

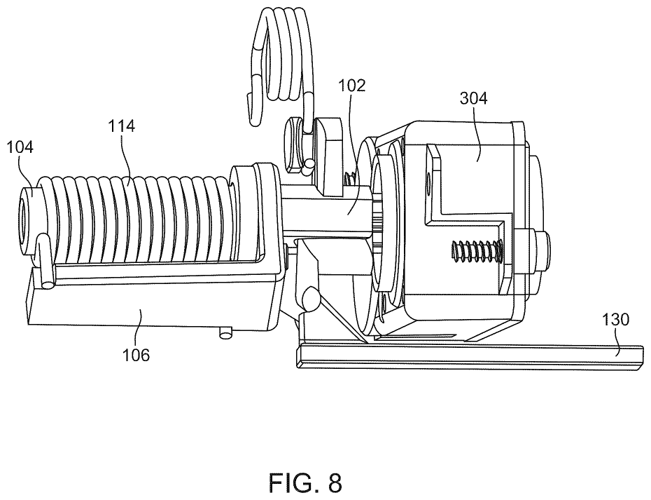

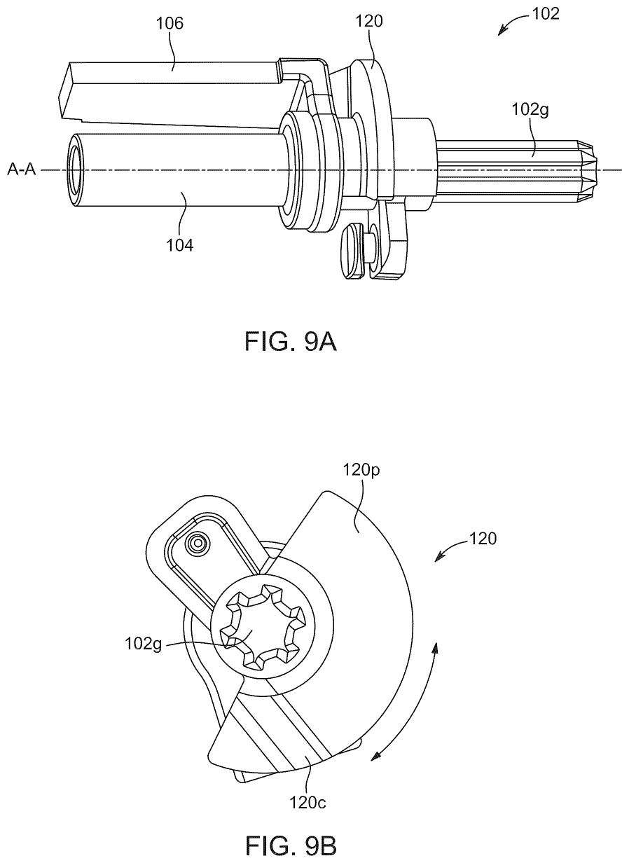

FIG. 9a illustrates an isometric view of a rotor element of the actuator in accordance with an embodiment of the present disclosure;

FIG. 9b illustrates a front view of the rotor element in accordance with an embodiment of the present disclosure;

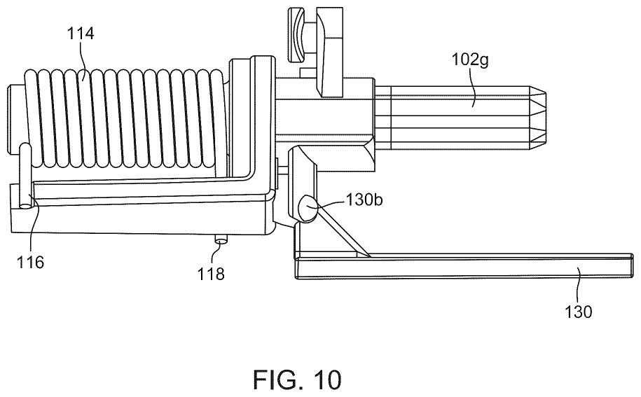

FIG. 10 illustrates a perspective view of the rotor element with a ball-shaped head in accordance with an embodiment of the present disclosure;

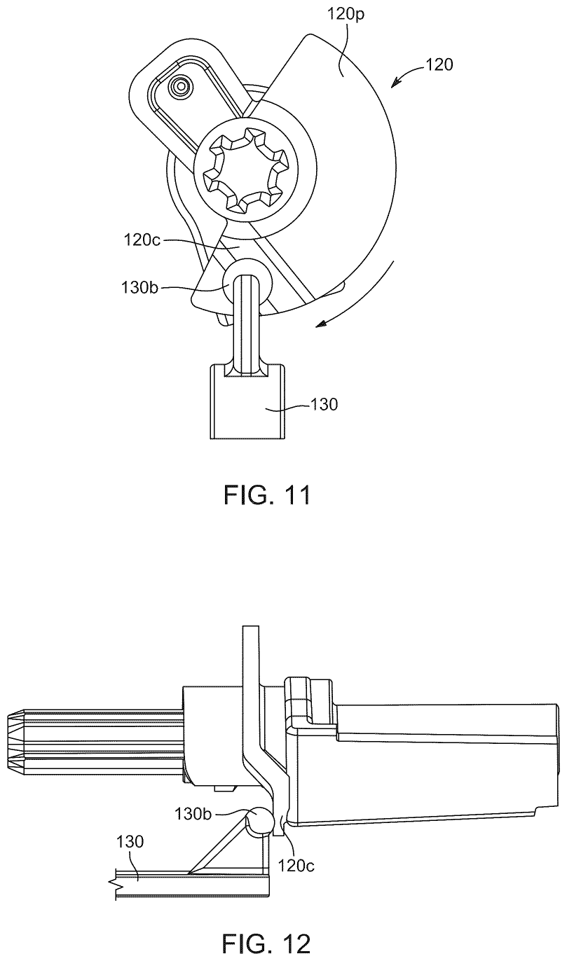

FIGS. 11-14 illustrate the perspective views of the rotor element having a contour and the ball-shaped head in accordance with an embodiment of the present disclosure;

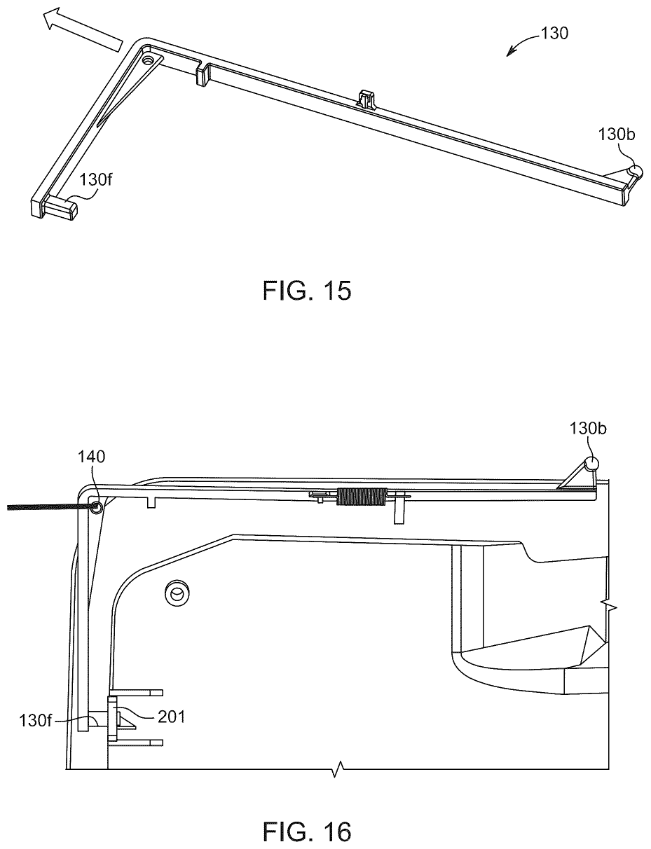

FIG. 15 illustrates a lever element in accordance with an embodiment of the present disclosure;

FIG. 16 illustrates the lever element and a cord element in accordance with an embodiment of the present disclosure;

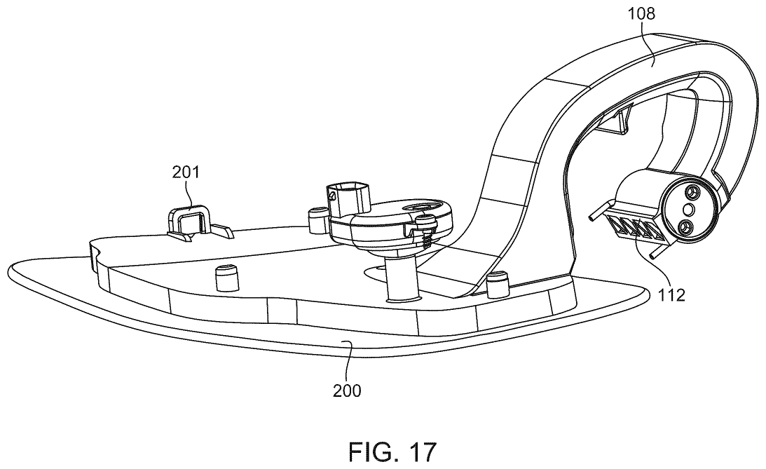

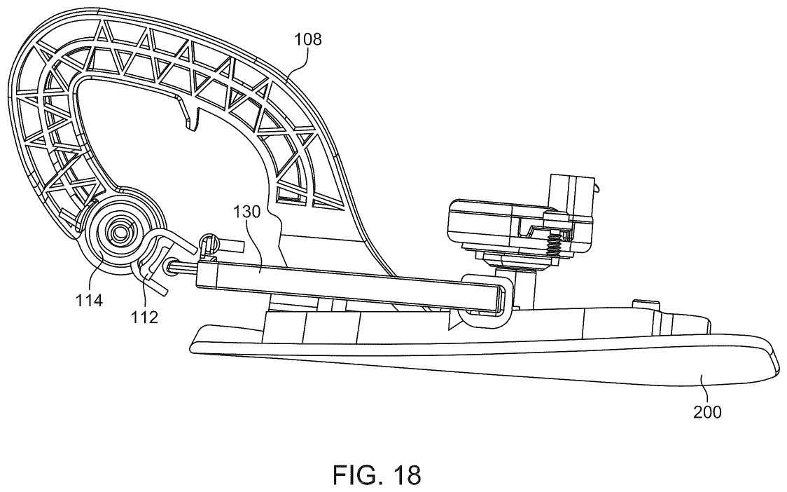

FIGS. 17-18 illustrate a lid element in accordance with an embodiment of the present disclosure;

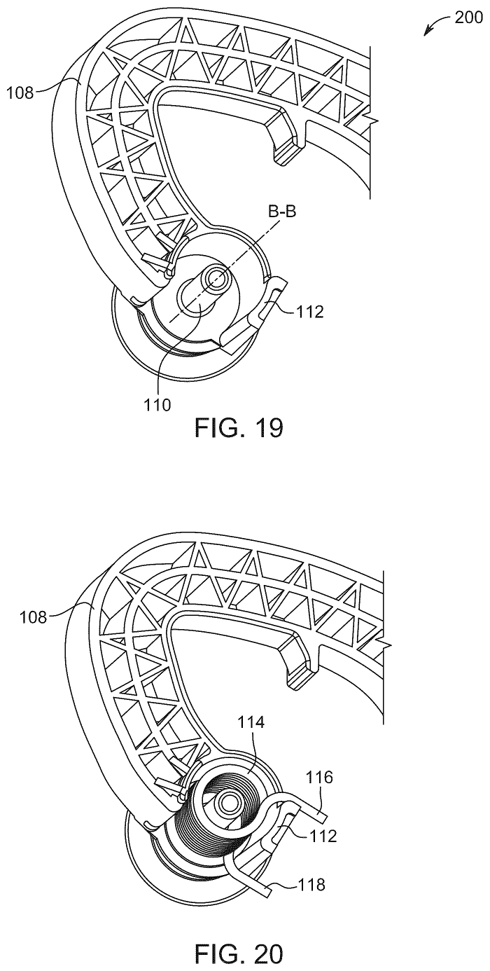

FIGS. 19-20 illustrate an arm element of the lid element in accordance with an embodiment of the present disclosure;

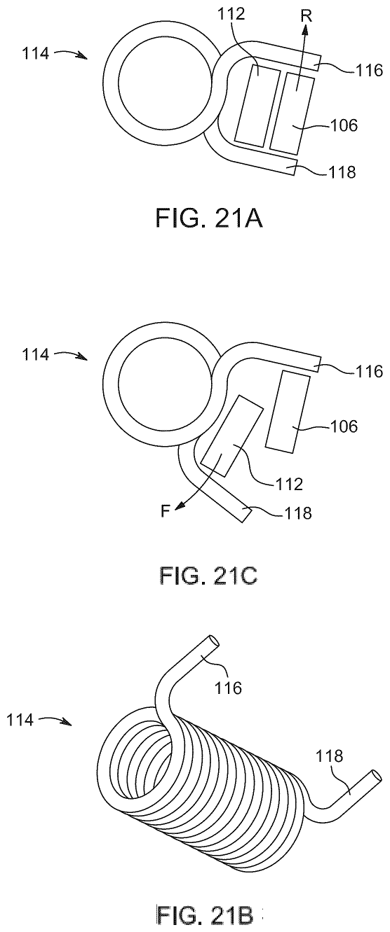

FIGS. 21A and 21C illustrate a rotor towing arm and a lid towing arm disposed between a first slew arm and a second slew arm in accordance with an embodiment of the present disclosure;

FIG. 21B illustrates a spring element with the first slew arm and the second slew arm in accordance with an embodiment of the present disclosure;

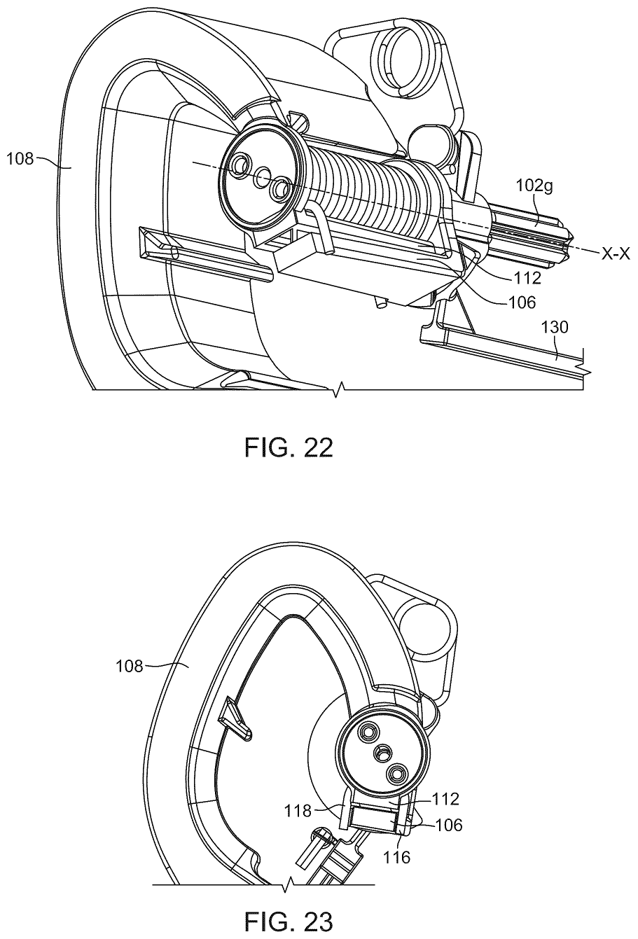

FIG. 22 illustrates an isometric view of the charging module excluding the lid element in accordance with an embodiment of the present disclosure;

FIG. 23 illustrates a perspective view of the FIG. 22 in accordance with an embodiment of the present disclosure; and

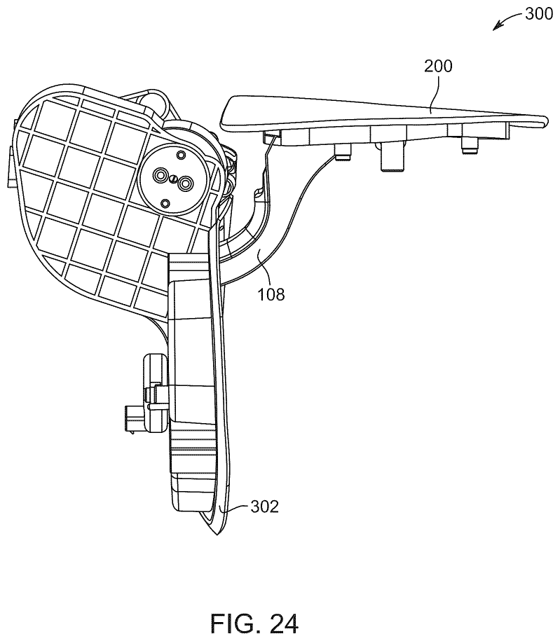

FIG. 24-30 illustrate various perspective views for open position of the lid element in the charging module in accordance with an embodiment of the present disclosure.

### DESCRIPTION OF EXEMPLARY EMBODIMENTS

The present invention is explained in more detail below with reference to the embodiments shown in the schematic figures:

FIG. 1 depicts a front of a charging module 300, e. g. in particular a mechatronic recharge module, according to an embodiment of the invention in a closed position. The charging module 300 may comprise a housing 302, an electric motor as an actuator 304 and a lid element 200.

FIG. 2 depicts a rear view of a charging module 300 according to an embodiment of the invention in a closed position. Part of the housing 302 may be connected with the lid element 200, and part of the housing 302 may cover at least a part of a drive axis A-A of the electric motor, at least a part of an output axis B-B of the lid element 200 and/or a spring element 114.

FIG. 3 depicts a front of a charging module 300 according to an embodiment of the invention without showing the housing 302.

A spring element 114 is configured to link the drive axis A-A and the output axis B-B, so that the output axis B-B is coupled with the drive axis A-A to open and close the lid element 200, see e. g. FIGS. 18 to 23.

FIG. 4 depicts a rear view of a charging module 300 according to an embodiment of the invention without showing the housing 302. An arm element 108 may connect the lid element 200 with the actuator 304, in particular with the electric motor. The arm element 108 may comprise or define an axis for aligning with the drive shaft 104, see e.g. FIG. 19. The axis may be defined by a pin, a cylinder element 110 or the like. The axis may be inserted in the drive shaft 104.

The arm element 108 may comprise a protrusion, in particular a towing arm or the like, to connect with the spring element 114, see e.g. FIG. 20.

A lever element 130 may be connected with the housing 302 and/or the lid element 200, see e.g. FIGS. 15 and 16. A cord element 140, a string or the like may be connected to the lever element 130. The cord element 140 may be threaded through a hole. The lever element 130 may be manually unlocked with the cord element 140, in particular by a missing of power, a defect of the electric motor or the like.

FIG. 5 depicts an isometric view of the same components of a charging module 300 according to an embodiment of the invention without showing the arm element 108 of the lid element 200, the lid element 200 and the housing 302.

FIG. 6 depicts another view of the embodiment of FIG. 5 without showing the arm element 108 of the lid element 200, the lid element 200, the housing 302 and the drive shaft 104.

FIG. 7 depicts another view of the embodiment of FIG. 5 showing a first protrusion of the rotor element 102, in particular a towing arm 106 of the rotor element 102. The towing arm 106 may be connected to the spring element 114.

Further, in an embodiment as show in FIG. 8, the actuator 304 comprises the rotor element 102 having the driving shaft 104 and the rotor towing arm 106. FIG. 9a also shows a perspective view of the rotor element 102. As shown, the rotor element 102 comprises the rotor gearing 102g and the disc-shaped protrusion 120. The rotor gearing 102g is configured to be rotated by the actuator 304 and to be coaxial with the drive shaft 104. Further, the drive shaft 104 is configured to define the drive axis A-A. Furthermore, the disc-shaped protrusion 120 is configured to configured to rotate with the drive shaft 104. In another embodiment, the disc-shaped protrusion 120 is configured to be attached to the drive shaft 104. Further, FIG. 9b shows the side view of the protrusion 120 attached to the rotor gearing 102g of the rotor element 102. As shown, the disc-shaped protrusion 120 comprises a planar portion 120p and the contour portion 120c such that the contour portion 120c is a depression with respect to the planar portion 120p.

As shown in FIG. 9, the towing arm 106 and the drive shaft 104 may be spaced from each other. According to an embodiment, the towing arm 106 and the drive shaft 104 may be in parallel, in particular, the towing arm 106 may be in parallel with the drive axis A-A.

FIG. 9(a) depicts an isometric view of a rotor element 102 defining a drive axis A-A. FIG. 9(b) depicts a front view of the rotor element 102. The rotor element 102 may comprise a shaft element 104, a rotor gearing 102g and a first protrusion as a towing arm 106. Further, the rotor element 102 may comprise protrusion 120 configured to connect with the lever element 130, in particular with a ball-shaped head 130b of the lever element 130, see FIG. 10.

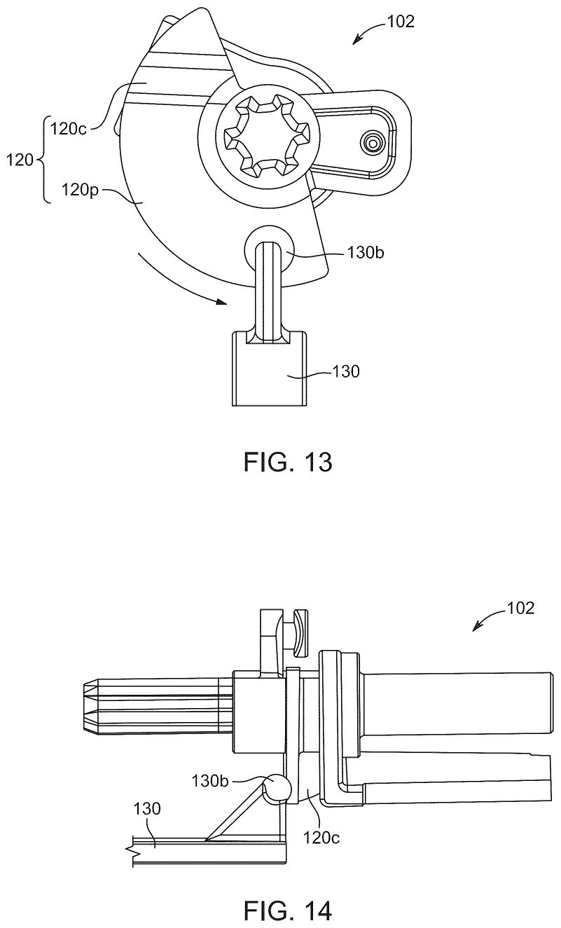

According to an embodiment, the protrusion 120 may have a pitch circle shape, a disc-like shape or the like. The protrusion 120 may comprise a contour 120c to guide the ball-shaped head 130b. FIGS. 11 and 12 show the position of the ball-shaped head 130b at the contour 120c in a closed position of the lid element 200, FIGS. 13 and 14 show the position of the ball-shaped head 130b at the contour 120c in an opened position of the lid element 200.

FIG. 21(a) and FIG. 22 shows the position of the towing arm 112; 106 of the lid element 200 and the rotor element 102 between slew arms 116; 118 of the spring element 114. The spring element 114 may comprise at least two slew arms 116; 118.

When the lid element 200 will be closed manually against the rotation of the drive shaft 104 of the electric motor, the towing arm 112 of the lid element 200 may be shifted relatively to the towing arm 106 of the rotor element 102, so that the lid element 200 can be at least partly manually closed without backward rotation of the actuator/electric motor. This may be achieved by the two slewing arms 116; 118 shifted against each other when contacting with the towing arm 112 of the lid element 200, see e. g. FIG. 21(c).

The spring element 114 may define a spring-clutch system. The spring element 114 may couple or link the separated drive axis A-A and output axis B-B to prevent damage on actuator 304 and on car electronics. Big advantage of spring clutch is the correlation between actuator 304 (drive shaft 104) and lid 200 (output axis B-B). With spring-clutch system the lid 200 (output B-B) will always follow the actuator 304 (driver) to position the lid 200. That means even when clutch is activated the lid 200 will follow automatically the actuator 304—means no calibration cycle/operation necessary to match lid 200 position to actuator 304 position. Due to split axis (output B-B/drive axis A-A linked via spring 114) implementation of spring-loaded locking mechanism is implemented without additional actuator. The drive axis A-A of actuator 304 is also controlling the locking mechanism.

Further, FIGS. 10 and 21b show the spring element 114 having a first slew arm 116 and a second slew arm 118 disposed at two opposite ends. In an embodiment, the spring element 114 is a torsion spring. Both slew arms 116, 118 may contact the towing arm 106 on opposite sides of the towing arm 106, in particular in the “unrotated position” as shown in FIG. 10.

FIG. 11 shows the closed position of the lid element and the rotation direction of the rotor to open the lid element 200. A ball-shaped head 130b of a lever element 130 may be positioned in a contour in the protrusion 120c of the rotor element 102. Another view is shown in FIG. 12. The contour in the protrusion 120c may be formed as a step, a notch, a channel or there like.

FIG. 13 shows an opened position of the lid element 200 and the rotation direction of the rotor to close the lid element 200. In this position, the ball-shaped head 130b is positioned outside the contour of the protrusion 120c, as also shown in FIG. 14.

FIGS. 15 and 16 shows an embodiment of a lever element 130. In FIG. 15, the tensile direction for unlock the lid element 200 is shown by the arrow.

The lever element 130 according to the shown embodiment in FIGS. 15 and 16 has a fixing point 130f and a ball-shaped head 130b. The fixing point 130f is configured to selectively engage with a contact point 201 at the lid element 200. As shown in FIG. 13, the ball-shaped head 130b is configured for engaging with the planar portion 120p during the opening and closing of the lid element 200. However, during the closed position of the lid element 200, the ball-shaped head 130 is configured to engage with the contour portion 120c causing the engagement of the fixing point 130f with the contact point 201 to lock the lid element 200. FIG. 15 also shows the hole for the cord element 140.

FIG. 16 also shows the cord element 140 connected to the lever element 130 through the hole for the cord element 140. Further, in an event of the actuator 304 malfunction, the cord element 140 is configured for manual disengagement of the fixing point 130f of the locking lever element 130 with the contact point 201 thereby unlocking the lid element 200.

A closed position of the lid element 200 is shown in FIG. 17. Further, FIG. 17 shows a perspective view of the lid element 200 comprising the arm element 108 and a contact point 201. Similarly, FIG. 18 shows a perspective view of the lid element 200 comprising the arm element 108. More specifically, FIG. 19 focuses the arm element 108 comprises the lid shaft 110 and a lid towing arm 112. Further, as shown, the lid shaft 110 defines the output axis B-B.

Further, referring to FIGS. 19, 20 and 22, the lid shaft 110 and the drive shaft 104 are coaxially inserted into each other to define a central axis of rotation X-X such that the rotor towing arm 106 and the lid towing arm 112 are disposed between the first slew arm 116 and the second slew arm 118, by pre-loading the spring element 114 around the central axis of rotation X-X. This leads to linking of the drive axis A-A and the output axis B-B. In addition, referring to FIG. 22, the rotor towing arm 106 and the lid towing arm 112 extend from the rotor element 102 and the arm element 108 correspondingly in opposite directions.

Further, FIG. 23 shows a rear view of the FIG. 22 illustrating the rotor towing arm 106 and the lid towing arm 112 disposed between the first slew arm 116 and the second slew arm 118.

As mentioned earlier, FIG. 21b shows the spring element 114 having the first slew arm 116 and the second slew arm 118 disposed at two opposite ends. Further, referring to FIG. 21a, the rotor towing arm 106 and the lid towing arm 112 are disposed between the first slew arm 116 and the second slew arm 118. In other words, in an event of actuation of the actuator, the rotor towing arm 106 is configured to engage with one of the first slew arm 116 or the second slew arm 118 based upon the rotation of the rotor element 102. Similarly, in an event of external force on the charging lid 200, the lid towing arm 112 is configured to engage with one of the first slew arm 116 or the second slew arm 118.

In an event of actuation of the actuator 304 and in an event of absence of an opposing external force F to the movement of lid element 200 as shown in FIG. 21a, the rotor towing arm 106 is configured to engage with the first slew arm 116 causing the second slew arm 118 to engage with the lid towing arm 112 thereby resulting in rotation R of the rotor towing arm 106 and the lid towing arm 112 together as a single rotary body in a first direction to enable transfer of torque from the rotor element 102 to the arm element 108 causing opening of the lid element 200.

Similarly, the rotor towing arm 106 is configured to engage with the second slew arm 118 causing the first slew arm 116 to engage with the lid towing arm 112 thereby resulting in rotation R of the rotor towing arm 106 and the lid towing arm 112 together as the single rotary body in a second direction to enable transfer of torque from the rotor element 102 to the arm element 108 causing closing of the lid element 200 in absence of the opposing external force F on the charging lid 200.

However, in event of opposing external force F on the charging lid 200 as shown in FIG. 21c, the spring element 114 is configured to absorb the opposing external force F applied on the lid element 200, resulting in a relative movement of the rotor towing arm 106 and the lid towing arm 112, thereby preventing the external force F from being transferred to the rotor element 102.

FIGS. 24 to 30 show an opened position of the lid element 200 of an embodiment of a charging module 300 according to the invention.

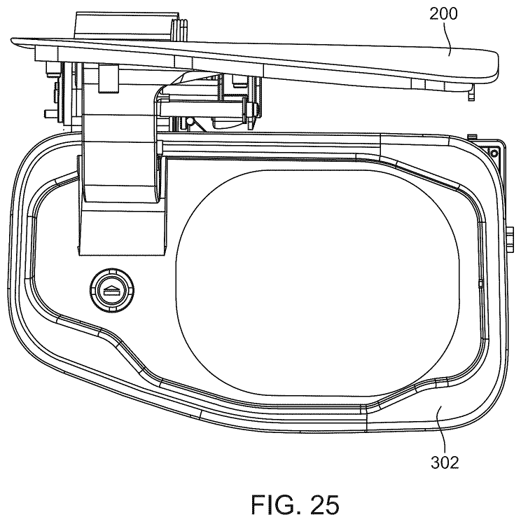

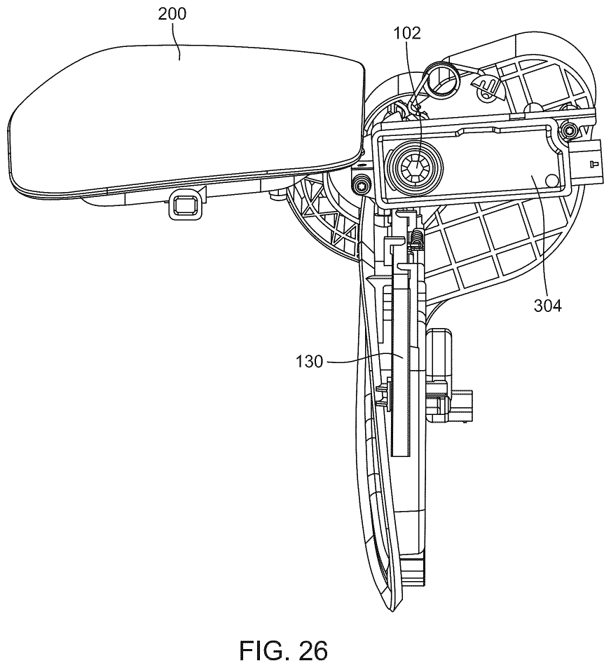

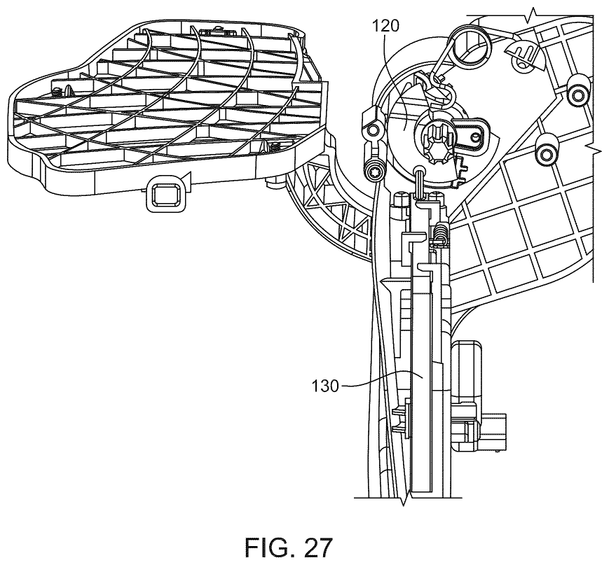

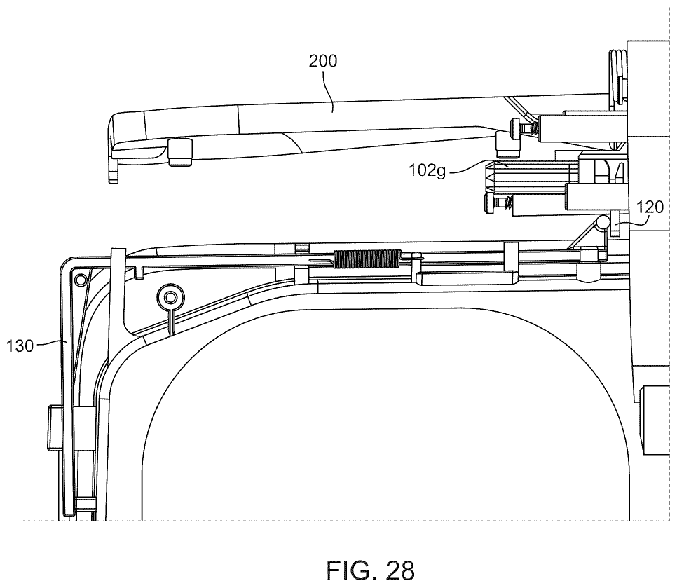

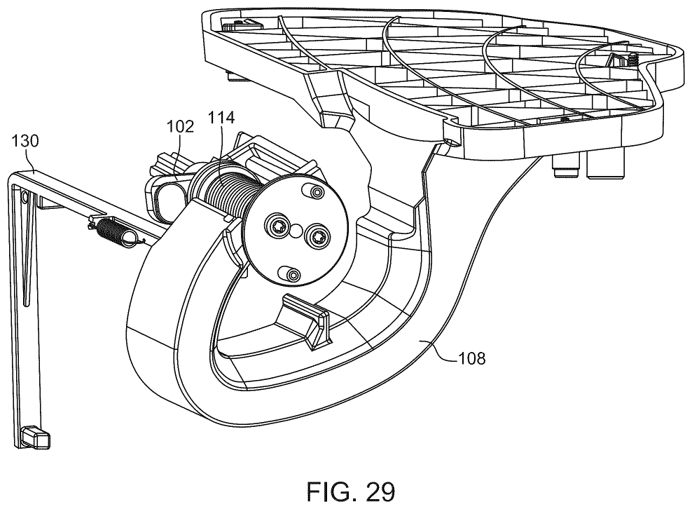

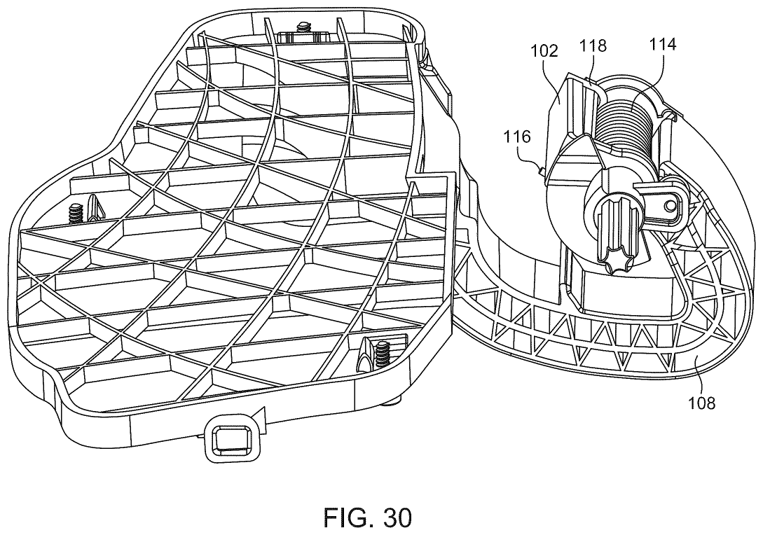

FIGS. 24-25 show the different perspective view of the charging module 300 depicting the housing 302, the lid element 200 and the arm element 108. Similarly, FIG. 26 shows the perspective view of the charging module 300 depicting the lid element 200, the lever element 130, the rotor element 102 and the actuator 304. In addition, FIG. 27 depict the disc-shaped protrusion 120 of the rotor element 102. Further, FIG. 28 depicts another perspective view of the charging module 300 comprising the lid element 200, the lever element 130, the rotor gearing 102g and the disc-shaped protrusion 120 of the rotor element 102. In a different perspective view of the charging module 300, FIG. 29 also depicts the spring element 114. Similarly, FIG. 30 depicts the first slew arm 116 of the spring element 114 and the second arm 118 of the spring element 114.

In the figures of the drawing, elements, features and components which are identical, functionally identical and of identical action are denoted in each case by the same reference designations unless stated otherwise.

Although specific embodiments are illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents.

Many other examples will be apparent to one skilled in the art upon reviewing the above specification. The embodiments were chosen and described in order to best explain the principles of the invention and its practical applications, to thereby enable others skilled in the art to best utilize the invention and various embodiments with various modifications as are suited to the particular use contemplated.

1. Charging module for an electric vehicle, with:
an actuator comprising a drive axis;
a lid element comprising an output axis or connected with an output axis; and
a spring element configured to link the drive axis and the output axis, so that the output axis is coupled with the drive axis to open and close the lid element.

2. The charging module according to claim 1, wherein
the actuator comprises a rotor element having a drive shaft defining the drive axis and a rotor towing arm.

3. The charging module according to claim 1, wherein
the lid element comprises an arm element having a lid cylinder element defining the output axis and a lid towing arm.

4. The charging module according to claim 1, wherein
the spring element comprises a first slew arm and a second slew arm disposed at two opposite ends, and/or the spring element is a torsion spring.

5. The charging module according to claim 2, wherein
wherein the lid cylinder element and the drive shaft are coaxially inserted into each other to define a central axis of rotation such that the rotor towing arm and the lid towing arm are disposed between the first slew arm and the second slew arm, by pre-loading the spring element around the central axis of rotation to achieve the linking of the drive axis and the output axis.

6. The charging module according to claim 2, wherein the spring element is configured to enable or disable transfer of torque between the rotor element and the arm element to achieve the opening and closing of the lid element.

7. The charging module according to claim 2, wherein
a rotor towing arm is configured to engage with a first slew arm causing a second slew arm to engage with a lid towing arm thereby resulting in rotation of the rotor towing arm and the lid towing arm together as a single rotary body in a first direction to enable transfer of torque from a rotor element to an arm element causing opening of the lid element in absence of an opposing external force on the lid element.

8. The charging module according to claim 2, wherein
the rotor towing arm is configured to engage with the second slew arm causing the first slew arm to engage with the lid towing arm thereby resulting in rotation of the rotor towing arm and the lid towing arm together as the single rotary body in a second direction to enable transfer of torque from the rotor element to the arm element causing closing of the lid element in absence of an opposing external force on the charging lid.

9. The charging module according to claim 2, wherein the spring element is configured to absorb an opposing external force applied on the lid element, resulting in a relative movement of the rotor towing arm and a lid towing arm, thereby preventing the external force from being transferred to the rotor element.

10. The charging module according to claim 2, wherein the rotor element further comprises a rotor gearing, coaxially to the drive shaft, configured to be rotated by the actuator.

11. The charging module according to claim 2, wherein the rotor towing arm and the lid towing arm extend from a rotor element and an arm element correspondingly in opposite directions.

12. The charging module according to claim 2, further comprising: a disc-shaped protrusion, configured to be attached to the drive shaft and the rotor gearing, and configured to rotate with the drive shaft, wherein the disc-shaped protrusion comprises a planar portion and a contour portion.

13. The charging module according to claim 2, further comprising a lever element having a fixing point and a ball-shaped head, wherein the fixing point is configured to selectively engage with a contact point at the lid element.

14. The charging module according to claim 13, wherein the ball-shaped head is configured for engaging with the planar portion during the opening and closing of the lid element, and for engaging with the contour portion causing the engagement of the fixing point with the contact point to lock the lid element during the closed position of the lid element.

15. The charging module according to claim 13, further comprising a cord element, connected to the lever element, configured for manual disengagement of the fixing point of the locking lever element with the contact point thereby unlocking the lid element during an event of the actuator malfunction.
